(19) United States
(12) Patent Application Publication
(10) Pub. No.: US 2017/0083865 A1
(43) Pub. Date: Mar. 23, 2017

(54) CONTEXT-BASED EXPERIENCE

(71) Applicant: HEWLETT PACKARD ENTERPRISE DEVELOPMENT LP, Houston, TX (US)

(72) Inventors: Jonathan GIBSON, Austin, TX (US); Scott Anthony GAYDOS, Emmaus, PA (US); Joseph A. MILLER, Herndon, VA (US)

(73) Assignee: HEWLETT PACKARD ENTERPRISE DEVELOPMENT LP, Houston, TX (US)

(21) Appl. No.: 15/305,621

(22) PCT Filed: Jun. 9, 2014
(86) PCT No.: PCT/US2014/041602

§ 371 Date: Oct. 20, 2016

(51) Int. Cl. G06Q 10/10; G06K 9/00

(52) U.S. Cl. CPC G06Q 10/10; G06K 9/00288; G06Q 50/26

(57) ABSTRACT

An example system includes an experience device having one or more experiences and a package device having one or more packages. Each experience of the experience device identifies a package, wherein identification of the package is context-based; calls the identified package, wherein the identified package accesses a device or service to obtain information to return to the experience; and selectively provides the information to a user.

### BACKGROUND

In many arenas, disparate tools are used to achieve desired goals. Often, the disparate nature of such tools creates inefficiencies. Nevertheless, use of disparate tools is often necessitated due to changing needs and changing conditions.

### BRIEF DESCRIPTION OF THE DRAWINGS

For a more complete understanding of various examples, reference is now made to the following descriptions taken in connection with the accompanying drawings in which:

FIG. 1 illustrates an example context-aware platform;

FIG. 2 illustrates an example system using the example context-aware platform of FIG. 1;

FIG. 3 is a schematic illustration of the operation of an example context-aware platform;

FIG. 4 illustrates an example implementation of an example context-aware platform; and

FIG. 5 illustrates an example process of the example context-aware platform.

### DETAILED DESCRIPTION

Various examples described below provide for a context-aware platform which allows for a seamless experience for a user. The user may be a person, an organization or a machine, such as a robot. The seamless experience may be achieved by, for example, providing an integrated ecosystem which automatically uses a variety of tools. For example, for an individual with a particular occupation, the example context-aware platform may provide a seamless experience through integration of the user's task list, calendar, contact list, location and other resources, as well as various services, such as turn-by-turn navigation. In one example, the platform includes an experience device having one or more experience modules, each of which correspond to a particular application, such as a user's occupation or a robot's purpose. Additionally, the example platform may include a package device having one or more packages which are accessed by the various experience modules. The packages may, in turn, access various information from a user or other resources and may call various services, as described in greater detail below. As a result, the user may be provided with a seamless experience with little or no input from the user.

As noted above, in many fields, disparate tools are used to achieve desired goals. Often, the disparate nature of such tools creates inefficiencies. Nevertheless, use of disparate tools is often necessitated due to changing needs and changing conditions. For example, in the case of a person going through a day, various tools may be used to achieve desired functions. Depending on the context, information from one tool may be used to manually provide an input to another tool. For example, a calendar may be used to determine the next appointment. Information from the calendar may be used to determine the address of the next appointment. The address may, in turn, be used as input into the navigation system of a car for directions. The example systems described herein provide for a context-aware platform for an integrated solution to reduce or eliminate such inefficiencies. Further, in various examples, experiences and packages may be created to provide an ecosystem for accommodating various environments and functionalities.

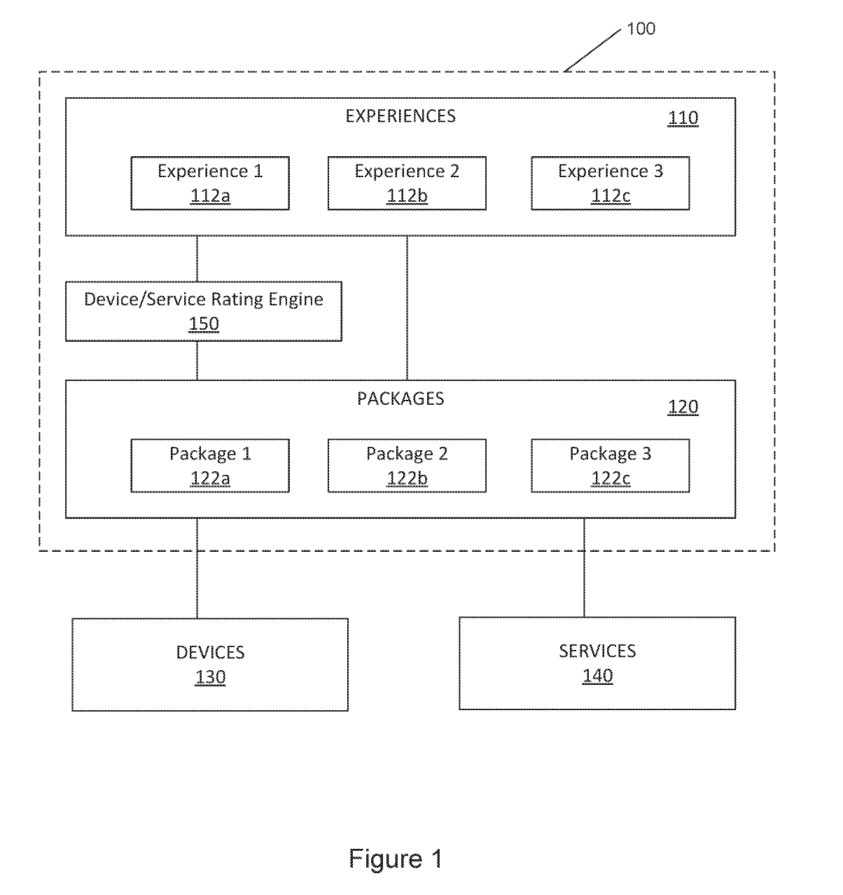

Referring first to FIG. 1, an example system for providing a context-aware platform is illustrated. In the illustrated example, the context-aware platform 100 includes an experience device 110 which includes a set of experiences 112a-c and a package device 120 which includes a set of packages 122a-c. The experience device 110 and the package device 120 may be servers or other such computing device. In some examples, the functions of the experience device 110 and the package device 120 may be provided by the same device. The set of experiences may include any number of experiences, and additional experiences may be added as needed. Each experience 112a-c may be directed to a particular industry, occupation, lifestyle or other such parameter. For example, various experiences may be directed to occupations such as probation officers, attorneys, sales persons, etc. The set of experiences 110 may be offered in a marketplace, such as an application store for mobile devices. In this regard, developers may be allowed to develop and add new experiences for various new industries, occupations or lifestyles, for example.

Each experience 112a-c in the set of experiences may access one or more packages 122a-c in a set of packages on the package device 120. In various examples, each package 122a-cperforms a designated function on behalf of an experience 112a-c. In this regard, each package 122a-c may access various devices 130 or services 140 to perform its function. For example, one example package 122a may perform a location-based function, such as providing turn-by-turn directions. In this example, the package 122a may access a mobile device of a user to obtain the current location of the user. The package 122a may further obtain an address of a destination from, for example, a contact list of the user or from the experience calling the package 122a. The package 122a may then access a service, such as a map service, to obtain the turn-by-turn directions to the destination and return the directions to the calling experience. Various other packages may provide various other functions, some examples of which are described below.

As noted above, the context-aware platform 100 may include access to various devices 130 and services 140. In addition to a user's mobile device, the devices 130 may include additional devices, including devices that are associated with the user or the user's mobile device. For example, the devices 130 may include devices connected to the mobile device (e.g., Bluetooth-connected peripherals), such as wearable devices including smart glasses, heart-rate sensors, or other such devices. Other devices may be associated with the user, such as a navigation system of the user's car. In some examples, the various packages 122a-c may use data collected by the devices. In one example, a package 122b may be provided to provide facial recognition service based on data collected by a camera or a video camera of a user device, such as smart glasses.

In various examples, the services 140 accessed by the packages 122a-c may include a variety of services. As noted above, one package may access a service for turn-by-turn directions, and another package may access a service for facial recognition. Other services may be provided for a specific experience 112a-c. For example, an experience directed for a particular occupation, such as a probation officer, may access a service provided by the probation service, such as a case management service. In this regard, a package 122a-c may access the case management service to identify the next case on a task list for the user (e.g., a probation officer). Various other devices and services are possible and are contemplated within the scope of the present disclosure.

As noted above, the packages 122a-c may access various devices and services to, for example, obtain data or other information. In many cases, multiple devices or services may offer the desired data or information. In this regard, the example context-aware platform of FIG. 1 is provided with a device/service rating engine 150. In various examples, the device/service rating engine 150 may rank various devices and/or services in order of priority for obtaining data. For example, turn-by-turn directions may be obtained from a map service or from a user device, such as the navigation system on the user's car. The device/service rating engine 150 may include rankings or logic which may be used by the package to determine which device and/or service to use. The determination may be based, at least in part, on the particular conditions. For example, in the case of the turn-by-turn directions, the determination may be based on the age of the available data, the quality of the available connection, etc. For example, in some cases, the map data available to the navigation system of the user's car may be outdated, or the user may manually set rating defaults that favor one service over another, resulting in a higher priority for the map service. As another example, the mobile device of the user may be subject to a data plan with limitations on data usage. Such limitation may be taken into account in ranking the devices and/or services. Further, such limitations may cause a higher priority for a service which provides a condensed version of data requiring lower data usage. Such ranking or prioritization logic may be used by the various packages 122a-c of the set of packages.

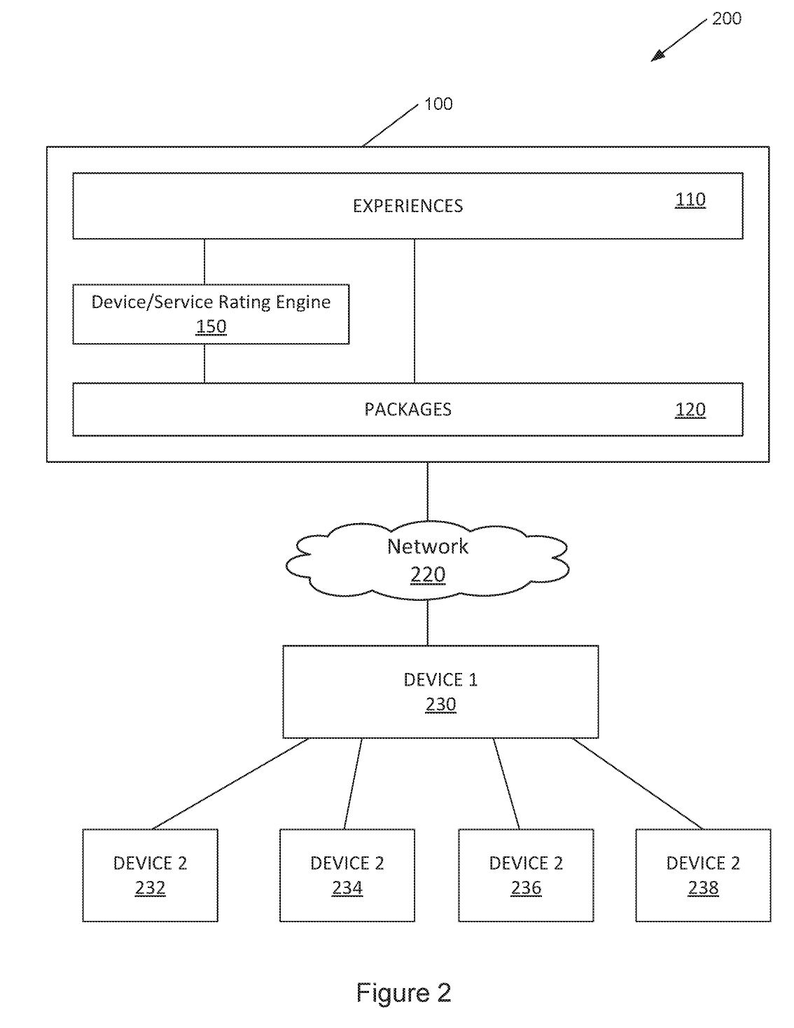

Referring now to FIG. 2, an example system using the example context-aware platform 100 of FIG. 1 is illustrated. In the example system 200 of FIG. 2, the example context-aware platform 100 may communicate with a user's main device 230. As noted above, the user may be a person, an organization or a machine (e.g., a robot). In various examples, the communication between the example context-aware platform (e.g., the package device 120 or the experience device 110) may be through a network 220, such as the Internet or another communication network. In various examples, the user's main device 230 is a mobile communication device, such as a smart phone. Of course, various other devices may be used and are contemplated within the scope of the present disclosure.

In various examples, the experience device 110 communicates with the user's main device 230 to provide information to the user and, if needed, to obtain telemetry information from the user's device, for example. Similarly, the package device 120 may also communicate with the user's main device 230 to, for example, obtain information that may be needed to perform the function of a particular package. In this regard, the experience device 110 and/or the package device 120 may also access, through the user's main device, other devices that may be connected to the user's main device 230. The other devices, such as devices 232-238, may include wearable devices (e.g., smart glasses), sensors (e.g., heart-rate monitors) and navigation systems (e.g., a navigation system of the user's car), for example, In addition to the user's main device 230 and other devices 232-238 accessible through the user's main device 230, the experience device 110 and the package device 120 may also access other devices not shown in FIG. 2. For example, other devices which may be associated with the user, such as additional computers associated with the user, may also be accessed.

Further, as described above with reference to FIG. 1, the package device 120 may access various services to perform functions of the various packages. In various examples, the various services may be accessed by the package device 120 through the network 220 or through other communication methods. Certain services may be provided within the context-aware protocol 100, for example.

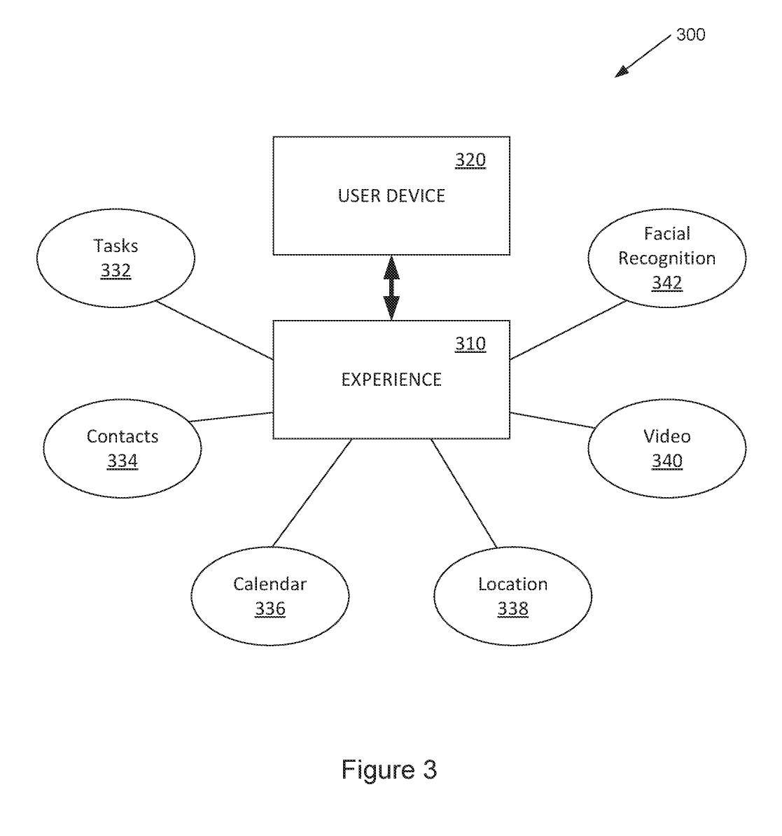

Referring now to FIG. 3, a schematic illustration of the operation of the example context-aware platform is provided. In the example illustration of FIG. 3, a selected experience 310 on the experience device 110 can provide the user of the user device 320 with a seamless, integrated user experience. The experience 310 may call upon various packages 332-342 in a particular order or in particular conditions to provide a complete experience. For example, in the case of a sales person, the experience 310 may call upon a tasks package 332 to identify the next prospective client for the sales person. A contacts package 334 may be called to obtain the address, phone number or email address of the next prospective client, for example. A calendar package 336 may be called to obtain schedule information in order to schedule a meeting with the prospective client, and a location package 338 may be called to obtain turn-by-turn directions to the address of the prospective client. Various other packages, such as a video package 340 to record video and a facial recognition package 342, may also be made available to the experience 310. Those skilled in the art will appreciate that numerous other packages may be provided to accommodate various types of experiences, and additional packages may be provided by developers of the experiences.

In various examples, developers may be provided with a standard set of packages which may be used to develop new experiences. In this regard, the developers may be provided with a set of common packages, such as the packages 332-342 described above, along with a list of inputs, outputs and application program interfaces (APIs) for each package. The developers may then provide customized experiences, such as the probation officer experience described above, which may include calls to the various packages. Such providing of common packages, inputs, outputs and APIs may encourage and facilitate the creation of additional experiences, thereby furthering and enhancing the context-aware ecosystem.

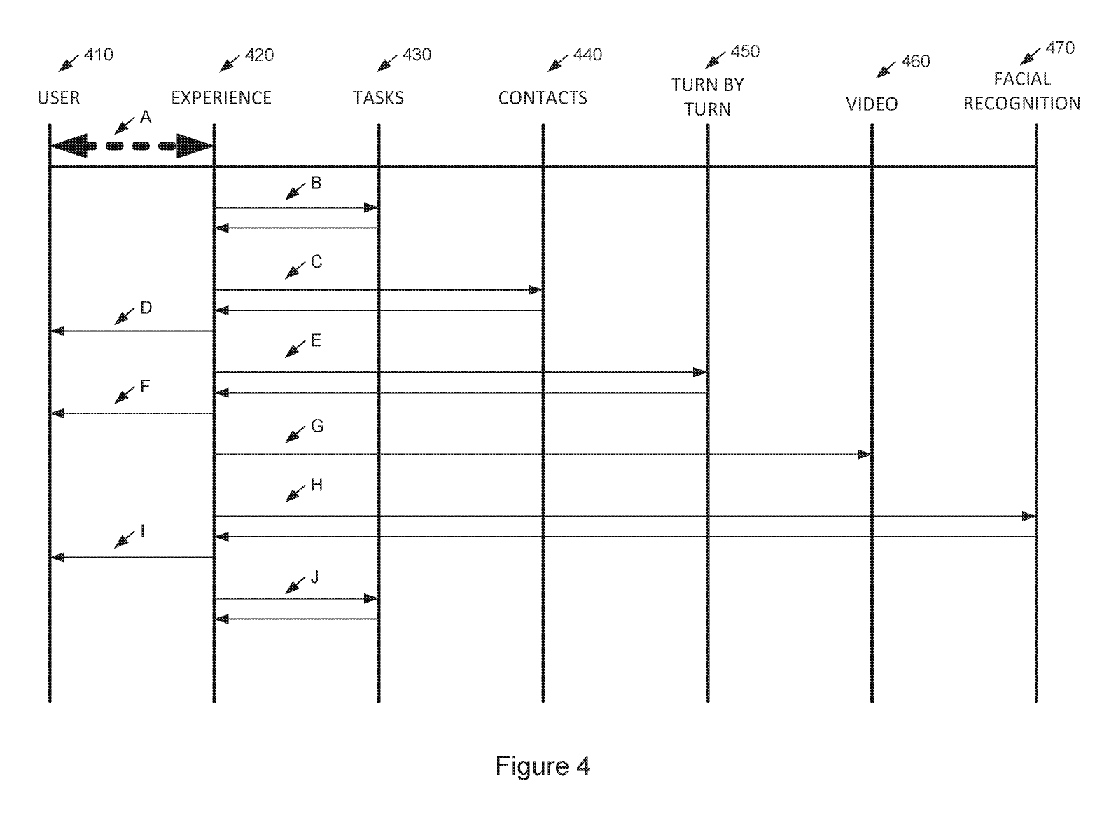

Referring now to FIG. 4, an example implementation of an example context-aware platform is illustrated. For purposes of understanding various applications of the disclosure, FIG. 4 is described for an implementation for a probation officer experience 420. As indicated by the dotted arrow “A”, a continuous or regular communication may be provided between the experience 420 and the user's main device 410. The probation officer experience 420 may call a tasks package 430 to retrieve the identity of the probation officer's next case, which may be returned to the experience 420, as indicated by the arrow “B” in FIG. 4. In this regard, the tasks package 430 may access a case management database of the probation system. In one example, the tasks package 430 may be automatically called by the experience 420 at a particular time of the day, such 9:00 a.m., to start the probation officer's work day. The tasks package 430 may also be called upon determination by the experience that the previous task (e.g., the previous probationer case) has been completed. Thus, in various examples, the tasks package 430 is called by the experience without any input from the probation officer.

Upon receiving the identity of the next case, the experience may call a contacts package 440 to obtain, for example, the residential address or workplace address of the probationer, as indicated by arrows “C” of FIG. 4. In this regard, the contacts package 440 may access a database of the probation system or the contacts on a mobile communication device of the probation officer, for example. As noted above, a device/service rating engine (e.g, the engine 150 of FIG. 1) may be used to rank the source of the desired information. Upon receiving the address information, the experience 420 may present the information on the user's smart phone, as indicated by arrow “D” of FIG. 4. In some examples, the functions of the tasks package and the contacts package may be combined into a single package.

The probation officer experience 420 may automatically, without input from the probation officer, obtain and provide turn-by-turn directions to the probation officer to the address of the probationer. As illustrated in FIG. 4, the experience 420 may call a turn-by-turn package 450 and obtain the turn-by-turn directions, as indicated by the arrow “E” of FIG. 4. In this regard, the experience 420 may provide an input to the turn-by-turn package 450, including the address of the probationer and the current location of the probation officer. As noted above, the turn-by-turn package 450 may obtain the directions from one of multiple sources, including a map service or a navigation system of a vehicle. Upon receiving the turn-by-turn directions from the turn-by-turn package 450, the experience 420 may automatically present the directions on the probation officer's mobile device or the probation officer's vehicle's navigation system, for example, as indicated by the arrow “F” of FIG. 4.

The experience may then monitor the probation officer's mobile device for the current location. Once the current location indicates that the probation officer is near the address of the probationer, the experience may call a video package 460, as indicated by the arrow “G” of FIG. 4. The proximity of the probation officer to the probationer's address may be determined by a pre-defined zone around the address or a predetermined distance to the address, for example. The video package 460 may obtain and/or record video or still images captured by a device associated with the probation officer. For example, the video package 460 may access a camera on smart glasses worn by the probation officer, a dash-mounted camera on the probation officer's vehicle or the digital camera on the probation officer's smart phone. The experience 420 may provide a notification to the probation officer indicating that images are being recorded. In various examples, the recorded images or video may be stored by the video package 460 on a storage device for later viewing or analysis.

Upon initiation of the capture of video or still images, the experience 420 may call a facial recognition package 470. The facial recognition package 470 may perform facial recognition of each face captured on a frame and perform a comparison to, for example, a probation system database. If a match is detected to a face in the database, the facial recognition package 470 may return the match to the experience, as indicated by the arrows “H”, and the experience 420 may provide an indication to the probation officer that a match has been detected, as indicated by the arrow “I” of FIG. 4. The indication to the probation officer may be a particular signal, such as a beep on the smart phone, or the identity of the matched individual. Additionally, the experience may obtain and provide the probation officer with other relevant information, such as any outstanding warrants for the matched individual.

When the experience determines that the task associated with the current probationer is complete, the experience 420 may call the tasks package 430 again to access the case management database and identify the next case. Thus, the experience 420 provide the probation officer 410 with a seamless and integrated experience.

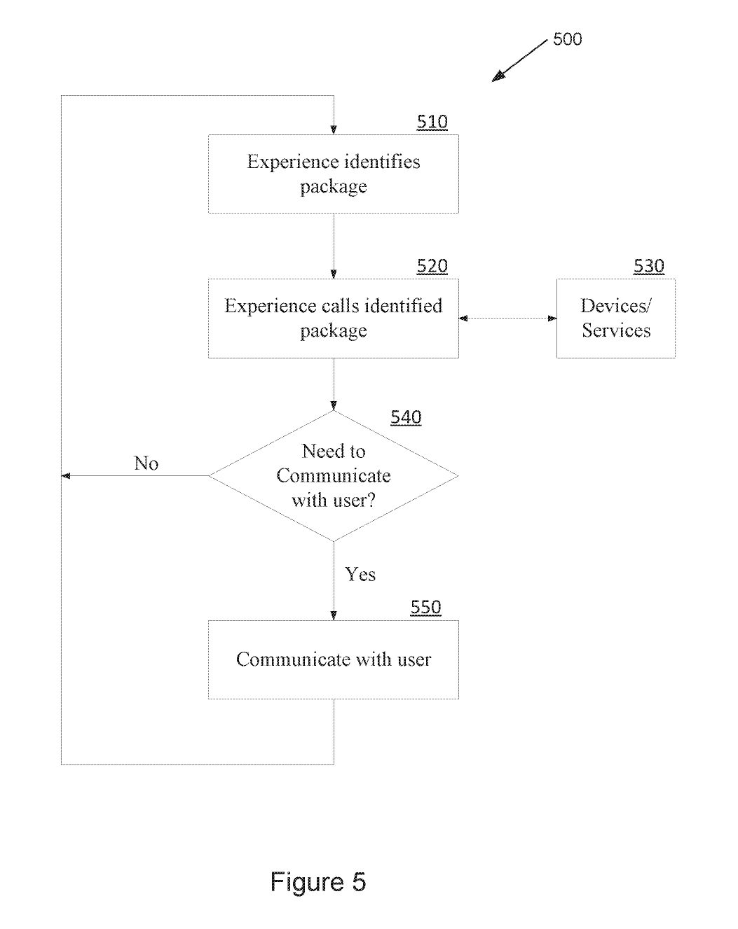

Referring now to FIG. 5, an example process of the example context-aware platform is illustrated. The process 500 may operate continuously and may call packages at certain landmarks, for example. In the example of FIG. 5, at block 510, the experience identifies the appropriate package to call. The identification of the package to be called may be situation-based, or context-based. For example, in the probation officer experience described above, the experience may identify the tasks package 430 at the start of a work day or the video package upon reaching a proximity threshold to the probationer's address, for example. Thus, identification of the package is determined based on the particular situation, or context.

Upon identification of the package, the experience calls the identified package (block 520). As described above, the various packages may access a variety of devices and/or services (block 530) and return a result of information to the experience. For certain packages, the experience may communicate with the user. For example, in the probation officer example described above, when the turn-by-turn package provides directions to the experience, the directions are provided to the probation officer. In other cases, the experience does not need to communicate with the user and may simply proceed to calling the next package.

Thus, at block 540, the experience determines whether there is a need to communicate with the user. If the determination is made that communication to the user is needed, the experience communicates the information to the user (block 550). In some examples, the experience may reformulate the information for more convenient or aesthetically pleasing presentation on the user device prior to communicating the information to the user. If the determinate is made that communication to the user is not needed, the experience proceeds to block 510 and identifies the next package to be called.

It is noted that upon identifying the next package to be called, the experience may not immediately call the next package. For example, in the probation officer example, the experience may determine that the video package 460 is to be called next as soon as the turn-by-turn directions are provided to the probation officer. However, the video package 460 may not be called until the probation officer's location is within a proximity threshold, for example. Thus, during that time, the experience may simply monitor the status of the probation officer.

Thus, various examples of the context-aware platform described herein can provide a seamless experience to the user with little or no input from the user. The experience may continuously monitor and identify the next package to be called based on the monitored status of the user. Further, various experiences can be provided for various industries, professions or lifestyles, and additional experiences may be provided by developers. The fixed set of packages may be accessible by all experiences, and additional packages may be provide for particular experiences. Thus, an eco-system for the experiences may be provided.

The various examples set forth herein are described in terms of example block diagrams, flow charts and other illustrations. Those skilled in the art will appreciate that the illustrated examples and their various alternatives can be implemented without confinement to the illustrated examples. For example, block diagrams and their accompanying description should not be construed as mandating a particular architecture or configuration.

What is claimed is:

1. A system, comprising:
an experience device having one or more experiences; and
a package device having one or more packages,
wherein each experience of the experience device:
identifies a package, wherein identification of the package is context-based;
calls the identified package, wherein the identified package accesses a device or service to obtain information to return to the experience; and
selectively provides the information to a user.

2. The system of claim 1, wherein each experience of the experience device is associated with an industry, a profession or a lifestyle

3. The system of claim 1, wherein at least one experience is associated with probation officer tasks, the experience calls to one or more of the following packages:
a task package for identifying a next probationer case;
a contacts package to retrieve address information associated with a probationer case;
a turn-by-turn package to obtain directions to an address associated with a probationer case;
a video package for recording video or still images within a proximity threshold of an address associated with a probationer case; or
a facial recognition package to identify faces captured on video or still images and matching the identified faces to faces in a probation database.

4. The system of claim 1, wherein at least one package of the package device is one of:
a task package for identifying a next task;
a contacts package to retrieve contact information;
a turn-by-turn package to obtain directions to a destination;
a video package for recording video or still images; or
a facial recognition package to identify faces captured on video or still images.

5. The system of claim 1, further comprising:
a rating engine to rank devices or services accessed by a package to perform a function.

6. The system of claim 1, wherein a package of the package device accesses one or more devices associated with a user.

7. The system of claim 6, wherein the devices associated with a user include a smart phone, a wearable device or a sensor.

8. An apparatus, comprising:
a processor; and
a memory device including computer program code, the memory device and the computer program code, with the processor, to cause the apparatus to:
identify a package, wherein identification of the package is context-based;
call the identified package, wherein the identified package accesses a device or service to obtain information to return to the experience; and
selectively provide the information to a user.

9. The apparatus of claim 8, wherein identification of the package is associated with an industry, a profession or a lifestyle.

10. The apparatus of claim 8, wherein identification of the package is associated with an occupation, and the occupation is a probation officer.

11. The apparatus of claim 8, wherein the package is one of:
a task package for identifying a next task;
a contacts package to retrieve contact information;
a turn-by-turn package to obtain directions to a destination;
a video package for recording video or still images; or
a facial recognition package to identify faces captured on video or still images.

12. The apparatus of claim 8, wherein the identified package accesses one or more devices associated with a user.

13. A method, comprising:
identifying a package, wherein identification of the package is context-based;
calling the identified package, wherein the identified package performs a function and returns a result; and
selectively communicating the result to a user.

14. The method of claim 13, wherein the identifying, calling and selectively communicating are repeated and wherein the result returned by the identified package contributes to the context-based identification of the next package.

15. The method of claim 13, the identified package accesses one or more devices associated with a user, wherein the devices associated with a user include a smart phone, a wearable device or a sensor.
